(19) United States
(12) Patent Application Publication
(10) Pub. No.: US 2003/0050220 A1
(43) Pub. Date: Mar. 13, 2003

(54) Articles and methods for reducing drying time of laundered fabric

(75) Inventors: Toan Trinh, Maineville, OH (US); John William Smith, Milford, OH (US); Helen Bernardo Tordil, Cincinnati, OH (US); Shulin Larry Zhang, West Chester, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/242,107

(22) Filed: Sep. 12, 2002

Related U.S. Application Data
(60) Provisional application No. 60/318,856, filed on Sep. 12, 2001.

(51) Int. Cl. D06B 1/00; D06F 39/00; C11D 3/00

(52) U.S. Cl. 510/521; 8/158; 68/235 R

(57) ABSTRACT

Articles, kits and methods for or reducing the drying time and/or temperature of wetted fabrics and/or improving the environmental impact of the laundry process. The article includes a fabric softening composition and a set of instructions associated with the composition, the set of instructions including an instruction to apply an effective amount of the fabric softening composition to fabric to reduce the drying time and/or temperature of the fabric and/or improve the environmental impact of the laundering process. Related methods for reducing fabric damage due to exposure of the fabrics to heat, for teaching a consumer to conserve energy and/or improve the environmental impact of the laundry process, and for promoting the use of fabric softening compositions are also disclosed.

### CROSS REFERENCE TO RELATED APPLICATIONS

This application claims priority under 35 U.S.C. § 119(e) to U.S. Provisional Application Serial No. 60/318,856, filed Sep. 12, 2001 (Attorney Docket No. 8712P).

### FIELD OF THE INVENTION

The field of the invention relates to the drying of fabrics that have been laundered and/or treated with or in an aqueous based solution. More specifically, the invention relates to compositions, articles and methods that when applied to such fabrics will reduce the time required to dry the fabrics in an electric and/or gas powered tumble dryer. As such, the invention further relates to methods of reducing fiber damage that results from tumble drying, as well as novel methods of conserving energy.

### DESCRIPTION OF THE PRIOR ART

U.S. Pat. No. 4,434,196, issued Feb. 28, 1984 to Robinson et al. discloses a process for accelerating the drying of a wet hydrophilic substrate by treating the substrate with a mixture of a cationic agent and an emulsified polyethylene wax in an aqueous medium.

U.S. Pat. Nos. 4,810,253, issued Mar. 7, 1989 and 4,848,981 issued Jul. 18, 1989, both to Kasprzak et al., each discloses a method wherein an amino or amido-functional silicone is dispersed in the rinse water to improve the flow of water out of textiles during the subsequent spin-separation of water resulting in less residual water.

U.S. Pat. Nos. 5,080,810, issued Jan. 14, 1992 to Smith et al., and 5,196,128, issued Mar. 23, 1993 to Crutcher et al. disclose fabric softeners in dryer sheet and liquid forms.

### SUMMARY OF THE INVENTION

The present invention provides an article of manufacture for reducing the drying time of laundered fabrics and improving the environmental impact. The article includes a fabric softening composition in a package in association with a set of instructions for use the fabric softening composition to obtain at least one of the following desirable benefits, viz, reduction of drying time, reduction of environmental impact, such as, energy savings, rapidly biodegradable fabric softening active, reduction of volatile organic compound/perfume loss, and/or reduction of fabric damage, and to ensure that the consumer knows what benefits can be achieved, and how best to obtain these benefits. The set of instructions includes an instruction to use an effective amount of the fabric softening composition, preferably in at least two consecutive laundering process cycles, more preferably in all laundering process cycles, to reduce the drying time of the fabric and improving the environmental impact, e.g., saving energy. Optionally, but preferably, the fabric softening composition is selected from the group consisting of rinse added fabric softening compositions and dryer added fabric softening compositions and more preferably, includes a dihydrocarbyl quaternary ammonium fabric softening compound that is rapidly biodegradable. Preferably, the set of instructions will include an instruction to reduce the timed drying of laundered fabrics by at least 5%, preferably at least 6%, more preferably at least 7% and even more preferably by at least 8% of the time required to dry fabrics laundered without a fabric softening composition. Further, the instructions can optionally include an instruction to use a clothes dryer having a moisture sensor that is capable of sensing the moisture on the fabrics and that is thereby capable of automatically reducing the drying time of the fabric.

The present invention further provides a kit for reducing the drying time of laundered fabrics. The kit includes a fabric dryer and a set of instructions associated with the fabric dryer. The set of instructions includes an instruction to use a fabric softening composition in at least two consecutive laundering process cycles of a fabric, preferably in all laundering cycles, to reduce the drying time of the fabric. Optionally but preferably, the fabric dryer will have a moisture sensor that is capable of sensing moisture in fabrics and that will automatically determine when to terminate the drying cycle. Preferably, the set of instructions will include an instruction to reduce the timed drying of laundered fabrics by at least 5%, preferably at least 6%, more preferably at least 7% and even more preferably by at least 8% of the time required to dry fabrics laundered without a fabric softening composition.

The present invention further provides for the use of a fabric softening composition in at least two consecutive laundering process cycles, preferably in all laundering cycles, to reduce the drying time of laundered fabrics. It is discovered that a multiple treatment of fabric with the fabric softening composition of the present invention in consecutive laundering process cycles further reduces the drying time, as compared to the benefit obtained from the initial treatment cycle.

In a process aspect of the present invention a method for reducing the drying time of laundered fabrics is provided. The method includes the steps of providing a fabric softening composition and providing a set of instructions in association with the fabric softening composition. The set of instructions will include an instruction to apply the fabric softening composition to the fabrics, preferably during at least two consecutive laundering process cycles, more preferably in all laundering process cycles, to obtain a reduction in the drying time of the fabric. Preferably, the instructions associated with the fabric softening composition are displayed on a package for the composition, posted at the point of sale adjacent the composition, and/or posted on a global computer network at an address associated with the composition. Optionally but preferably, the set of instructions will include an instruction to reduce the timed drying of laundered fabrics by at least 5%, preferably at least 6%, more preferably at least 7% and even more preferably by at least 8% of the time required to dry fabrics laundered without a fabric softening composition. Similarly, the set of instructions can optionally include an instruction to use a clothes dryer having a moisture sensor and that is thereby capable of automatically reducing the drying time of the fabric. It is again optional but preferred, that the set of associated instructions includes a recommendation and/or endorsement by a government agency, non-profit organization, utility provider, appliance manufacturer or some combination thereof. This method of reducing the drying time of a fabric can further include the steps of applying the fabric softening composition to the fabrics and drying the fabrics in a fabric dryer.

In another process aspect of the present invention, a method for reducing the energy consumed during a laundering process that includes drying the fabrics in a fabric dryer is provided. The method includes the steps applying a fabric softening composition to the fabrics, preferably during at least two consecutive laundering process cycles, more preferably in all laundering process cycles, and drying the fabrics in a fabric dryer such that the amount of energy consumed can be reduced by reducing the time required to dry the fabrics, reducing the temperature at which the fabrics are dried or some combination thereof.

In a related process aspect of the present invention, a method for improving the environmental impact during a laundry process that includes the use of a fabric softening composition is provided. The method includes the steps applying a fabric softening composition comprising biodegradable fabric softener actives and/or substantive perfume ingredients to the fabrics, preferably during at least two consecutive laundering process cycles, more preferably in all laundering process cycles, and drying the fabrics in a fabric dryer such that the amount of energy consumed can be reduced by reducing the time required to dry the fabrics, the fabric softener active is rapidly degraded in the environment, the perfume lost during the laundry process is minimized, or some combination thereof.

In yet another process aspect of the present invention, a method for reducing fabric damage due to exposure of the fabrics to heat and/or tumbling action during a drying process in an automatic tumbling dryer is provided. The method comprising the steps of applying a fabric softening composition to the fabrics during at least two consecutive laundering process cycles, preferably in all laundering process cycles, and drying the fabrics in a fabric dryer such that the amount of fabric damage is reduced by reducing the time required to dry the fabrics, reducing the amount of tumbling in the dryer due to a reduction in drying time, reducing the temperature at which the fabrics are dried, or some combination thereof.

In yet still another process aspect of the present invention, a method of teaching a consumer to conserve energy is provided. The method includes the step of informing a consumer that the treatment of laundered fabrics with a fabric softening composition during at least two consecutive laundering process cycles, more preferably in all laundering process cycles, will enable the consumer to reduce the time required to dry those fabrics.

In still a further process aspect of the present invention, a method of promoting the use of fabric softening compositions is provided. The method includes the steps of informing a consumer that the treatment of laundered fabrics with a fabric softening composition during at least two consecutive laundering process cycles, more preferably in all laundering process cycles, will reduce the time required to dry those fabrics.

All percentages and ratios used herein are expressed as percentages by weight unless otherwise indicated. All temperatures are expressed in degrees Celsius unless otherwise indicated. All cited documents are incorporated herein by reference.

### DETAILED DESCRIPTION OF THE PREFERRED EMBODIMENTS

### I. Articles Of The Present Invention

The articles of the present invention comprise a fabric softening composition and a set of instructions associated with the fabric softening composition.

A. Fabric Softening Compositions

The fabric softening compositions that are useful in the articles, kits and methods of the present invention include fabric softening compositions in a variety of forms including liquids, gels, pastes, granules and solids whether such forms are applied directly to the fabric, or added to the wash or rinse cycle solutions. Likewise, fabric softening compositions that are applied to a substrate for addition to the dryer with the fabrics can also be used to advantage.

To reduce the drying time, the fabric is treated with an effective amount of fabric softening active. For a rinse-added composition, the effective level of softening active needed is typically from about 0.5 to about 5 grams of softening active per kilogram of dry fabric, preferably from about 1 to about 4, more preferably from about 1.5 to about 3 grams of softening active per kilogram of fabric. For a dryer-added composition, the effective level of softening active needed is typically from about 0.1 to about 3 grams of softening active per kilogram of fabric, preferably from about 0.2 to about 2, more preferably from about 0.3 to about 1.2 gram of softening active per kilogram of fabric. The use of smaller amounts of softening active than the effective levels given hereinabove results in lower drying time reduction benefit, and the use of larger amounts than the effective levels results in a waste of softening active, thus negatively impacting the environment, and/or lower the drying time reduction benefit.

A liquid rinse-added composition typically contains from about 1% to about 75%, preferably from about 2% to about 65%, more preferably from about 3% to about 45%, and even more preferably from about 4% to about 35% by weight of the composition, of a fabric softening active. For a dryer-added composition, the levels are from about 1% to about 99%, preferably from about 10% to about 80%, more preferably from about 20% to about 70%, and even more preferably from about 25% to about 60% of fabric softening active. Depending on the concentration of the fabric softening active in the fabric softening composition, the set of instructions in association with said composition comprises an instruction to direct the consumer to apply an effective amount of the fabric softening composition, in order to provide an effective level of fabric softening active to fabric to achieve the desired benefit or benefits.

Rinse-added fabric softening compositions of the current invention comprise mainly fabric softening active, while wash-added fabric softening compositions can either comprise mainly fabric softening active or both softening active and compatible laundry surfactants, the so-called two-in-one detergent and softener compositions.

The rinse-added fabric softening compositions containing fabric softening actives herein can comprise liquid compositions that can be either dispersions or clear.

Dispersion Compositions

Stable “dispersion” compositions can be prepared like those disclosed in U.S. Pat. No. 4,661,269, issued Apr. 28, 1987, to T. Trinh et al., and in U.S. Pat. No. 5,545,340, issued Aug. 13, 1996, to Wahl et al., said patents being incorporated herein by reference. Suitable optional components in addition to the softening active are disclosed hereinafter. The dispersion liquid compositions herein can be both dilute and concentrated, but are preferably concentrated.

Clear Compositions

Stable clear compositions can be prepared like those disclosed in copending U.S. patent application Ser. No. 08/983,542, filed Sep. 25, 1998, Trinh et al., including compositions comprising an effective amount of 2,2,4-trimethyl-1,3-pentanediol, the ethoxylate, diethoxylate, or triethoxylate derivatives of 2,2,4-trimethyl-1,3-pentanediol, or 2-ethyl-1,3-hexanediol, and in copending U.S. patent application Ser. No. 09/309,128, filed May 10, 1999, Frankenbach et al., U.S. Pat. No. 5,399,272 issued Mar. 21, 1995 to Swartley et al., said patent and patent applications are incorporated herein by reference.

Fabric Softening Actives

Any fabric softening active, including quaternary and non-quaternary softening actives, with saturated, partially saturated, unsaturated an/or highly unsaturated, with straight, linear alkyl chains and/or branched alkyl groups, can be use in the fabric softening composition of the present invention. The fabric softening actives can be selected from cationic, nonionic, and/or amphoteric compounds. Typical of the cationic softening compounds are the dihydrocarbyl quaternary ammonium compounds or amine precursors thereof.

Suitable fabric softening actives comprise hydrocarbyl groups being a long hydrocarbon chain that can be saturated, unsaturated, highly unsaturated, linear, branched, or combinations thereof. However, it is preferably that the hydrocarbon chains are unsaturated with an Iodine Value of about 20 or higher.

For both liquid and solid fabric softening compositions it is preferred that the softening active is rapidly biodegradable. As used herein, “rapidly biodegradable” refers to softening actives that have long hydrocarbon chains that are interrupted at least by one ester, amide or some other functional group that is capable of being hydrolyzed so as to promote more rapid biodegradation of the hydrocarbon chain in the environment.

Fabric softening actives that can be used herein are disclosed, at least generically for the basic structures, in U.S. Pat. Nos.: 3,408,361, Mannheimer, issued Oct. 29, 1968; 4,709,045; Kubo et al., issued Nov. 24, 1987; 4,233,451, Pracht et al., issued Nov. 11, 1980; 4,127,489, Pracht et al., issued Nov. 28, 1979; 3,689,424, Berg et al., issued Sep. 5, 1972; 4,128,485, Baumann et al., issued Dec. 5, 1978; 4,161,604, Elster et al., issued Jul. 17, 1979; 4,189,593, Wechsler et al., issued Feb. 19, 1980; 4,339,391, Hoffman et al., issued Jul. 13, 1982 3,861,870, Edwards and Diehl; 4,308,151, Cambre; 3,886,075, Bernardino; 4,233,164, Davis; 4,401,578, Verbruggen; 3,974,076, Wiersema and Rieke; 4,237,016, Rudkin, Clint, and Young; 4,885,102, Yamamura et al., issued Dec. 5, 1989; 4,937,008, Yamamura et al., issued Jun. 26, 1990; and 5,133,885, Contor et al., issued Jul. 28, 1992; Case 4768C, Trinh et al.; and European patent applications 91/336,267, Rutzen et a.l. and 91/423,894, Contor et al. and International Patent WO 91/01295, Trius et al., published Feb. 7, 1991, all of said patents and applications being incorporated herein by reference.

Other preferred fabric softening actives for liquid rinse-added compositions are disclosed in U.S. Pat. No. 4,661,269, issued Apr. 28, 1987, to T. Trinh, E. H. Wahl, D. M. Swartley and R. L. Hemingway. Biodegradable ester and/or amide linked fabric softening actives are disclosed, e.g., in U.S. Pat. No. 5,545,340, issued Aug. 13, 1996, to Wahl et al. Biodegradable unsaturated ester and/or amide linked fabric softening actives in concentrated clear compositions are disclosed in U.S. Pat. No. 5,759,990, issued Jun. 2, 1998 in the names of Wahl, Tordil, Trinh, Carr, Keys, and Meyer, and in U.S. Pat. No. 5,747,443, issued May 5, 1998 in the names of Wahl, Trinh, Gosselink, Letton, and Sivik. All said patents are incorporated herein by reference. Examples of suitable amine softening actives that can be used in the present invention are disclosed in PCT application WO 99/06509, K. A. Grimm, D. R. Bacon, T. Trinh, E. H. Wahl, and H. B. Tordil, published on Feb. 11, 1999, said application being incorporated herein by reference.

A preferred fabric softening composition herein uses fabric softening active with unsaturated and/or branched hydrocarbon chains, preferably biodegradable. These unsaturated and/or branched fabric softening actives allow the preparation of concentrated liquid fabric softening compositions. Fabric softening actives with saturated and/or low degree of unsaturation, e.g., Iodine Value of less than about 10, and fabric softening actives with unsaturated chains having the trans configuration, can normally provide a better softening performance per unit weight, but are more difficult to concentrate, thus can be used in compositions with lower levels of fabric softening active, typically below about 30%, preferably below 25%, more preferably below 20%, by weight of the composition.

Preferred fabric softening actives of the invention comprise special dihydrocarbyl quaternary ammonium compounds wherein each hydrocarbyl group comprises a functional group selected from the group consisting of ester, amide, or mixtures thereof. These compounds are commonly called diester quaternary ammonium fabric softening active (DEQA) and have the following general formula:

The first type of DEQA active has the general formula:

{R₄₋ₘ—N⁺—[(CH₂)ₙ—Y—R¹]ₘ} X^{-tm (DEQA} 1)

wherein each R substituent is either hydrogen, a short chain C₁-C₆, preferably C₁-C₃ alkyl or hydroxyalkyl group, e.g., methyl (most preferred), ethyl, propyl, hydroxyethyl, and the like, poly (C₂₋₃ alkoxy), preferably polyethoxy, group, benzyl, or mixtures thereof, each mn is 2 or 3; each n n is from 1 to about 4, preferably 2; each Y is —O—(O)C—, —C(O)—O—, —NR—C(O)—, or —C(O)—NR—; the sum of carbons in each R¹, plus one when Y is —O—(O)C— or —NR—C(O)—, is C₁₂-C₂₂, preferably C₁₄-C₂₀, with each R¹ being a hydrocarbyl (which can be alkyl, monounsaturated alkenyl and/or polyunsaturated alkenyl group), or substituted hydrocarbyl group, and X⁻ can be any softener-compatible anion, preferably, chloride, bromide, methylsulfate, ethylsulfate, sulfate, and nitrate, more preferably chloride or methyl sulfate.

As used herein, when the DEQA diester (m=2) is specified, it can include the monoester (m=1) and/or triester (m=3) that are present. Preferably, at least about 30% of the DEQA is in the diester form, and from 0% to about 30% can be DEQA monoester, e.g., there are three R groups and one R¹ group. For fabric softening performance, under no/low detergent carry-over laundry conditions the percentage of monoester should be as low as possible, preferably no more than about 15%. However, under high, anionic detergent surfactant or detergent builder carry-over conditions, some monoester can be preferred.

The second type of diester quaternary ammonium active has the general formula:

[R₃N⁺CH₂CH(YR¹)(CH₂YR¹)]X⁻ DEQA (2)

wherein each Y, R, R¹, and X⁻ have the same meanings as before. Such compounds include those having the formula:

[CH₃]₃ N⁽⁺⁾[CH₂CH(CH₂O(O)CR¹)O(O)CR¹]Cl⁽⁻⁾

wherein each R is a methyl or ethyl group and preferably each R¹ is in the range of C₁₅ to C₁₉. An example of a preferred DEQA (2) is the “propyl” ester quaternary ammonium fabric softener active having the formula 1,2-di(acyloxy)-3-trimethylammoniopropane chloride.

These biodegradable quaternary ammonium fabric softening actives preferably contain the group C(O)R¹ which is derived, primarily from saturated fatty acids, such as stearic acid, but more preferably derived from partially saturated fatty acids and/or partially hydrogenated fatty acids from natural sources, e.g., derived from animal fat, such as tallow fatty acids. Also preferred are unsaturated fatty acids, e.g., oleic acid, and polyunsaturated fatty acids, such as those derived from vegetable oils, such as, canola oil, safflower oil, peanut oil, sunflower oil, corn oil, soybean oil, tall oil, rice bran oil, etc. Non-limiting examples of fatty acids (FA) are listed in U.S. Pat. No. 5,759,990 at column 4, lines 45-66. Fabric softening actives containing unsaturated and polyunsaturated fatty acids are preferred in formulating concentrated, clear fabric softening compositions of the present invention. Iodine Value (referred to as “IV” herein) is used to define the level of unsaturation of a fatty acid. As used herein, Iodine Value of the “parent” fatty acid, or “corresponding” fatty acid that the R¹ group is derived from, is also used to define the level of unsaturation of a fabric softening active. The IV of the parent fatty acids of these R¹ group is from about 0 to about 140, more preferably from about 40 to about 130, on the average. For concentrate, clear compositions, the IV is preferably from about 70 to about 140, more preferably from about 80 to about 130, and even more preferably from about 90 to about 115, on the average.

Mixtures of fatty acids can be used, and are preferred. Preferred DEQA softening actives containing an effective amount of molecules containing two ester linked hydrophobic groups [R¹C(CO)O—], are those that are prepared as a single DEQA from blends of all the different fatty acids that are represented (total fatty acid blend), rather than from blends of mixtures of separate finished DEQA's that are prepared from different portions of the total fatty acid blend.

Another DEQA softening active that is suitable for the formulation of the concentrated, liquid fabric softening compositions of the present invention, has the above formula DEQA (1) wherein one R group is a C₁₋₄ hydroxy alkyl group, or polyalkoxy group, preferably hydroxy alkyl, more preferably hydroxyethyl, group. An example of such a hydroxyethyl ester active is di(acyloxyethyl)(2-hydroxyethyl)methyl ammonium methyl sulfate, where the acyl is derived from the fatty acids described hereinbefore, e.g., oleic acid. Such DEQA is a quaternized product of condensation between: (a)-a fraction of saturated or unsaturated, linear or branched fatty acids, or of derivatives of said acids, said fatty acids or derivatives each possessing a hydrocarbon chain in which the number of atoms is between 5 and 21, and (b) triethanolamine, characterized in that said condensation product has an acid value, measured by titration of the condensation product with a standard KOH solution against a phenolphthalein indicator, of less than about 6.5. The acid value is preferably less than or equal to about 5, more preferably less than about 3. Indeed, the lower the AV, the better softness performance is obtained.

The acid value is determined by titration of the condensation product with a standard KOH solution against a phenolphthalein indicator according to ISO#53402. The AV is expressed as mg KOH/g of the condensation product.

For optimum softness benefit, it is preferred that the reactants are present in a molar ratio of fatty acid fraction to triethanolamine of from about 1:1 to about 2.5:1.

The DEQAs herein can also contain a low level of fatty acid, which can be from unreacted starting material used to form the DEQA and/or as a by-product of any partial degradation (hydrolysis) of the softener active in the finished composition. It is preferred that the level of free fatty acid be low, preferably below about 15%, more preferably below about 10%, and even more preferably below about 5%, by weight of the softener active.

The DEQA actives described hereinabove also include the neutralized amine softening actives wherein at least one R group is a hydrogen atom. A non-limiting example of actives of this type is the chloride salt of (unsaturated alkoyloxyethyl)(unsaturated alkylamidotrimethylene)methylamine. Other examples of suitable amine softening actives are disclosed in PCT application WO 99/06509, K. A. Grimm, D. R. Bacon, T. Trinh, E. H. Wahl, and H. B. Tordil, published on Feb. 11, 1999, said application being incorporated herein by reference.

Fabric softening actives carrying more than one positive quaternary ammonium charge are also useful in the rinse-added compositions of the present invention. An example of this type of softening active is that having the formula:

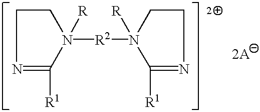

wherein each R is H or a short chain C₁-C₆, preferably C₁-C₃ alkyl or hydroxyalkyl group, e.g., methyl (most preferred), ethyl, propyl, hydroxyethyl, and the like, benzyl, or (R² O)₂₋₄H; each R¹ is a C₆-C₂₂, preferably C₁₄-C₂₀ hydrocarbyl, or substituted hydrocarbyl substituent, preferably C₁₀-C₂₀ alkyl or alkenyl (unsaturated alkyl, including polyunsaturated alkyl, also referred to sometimes as “alkylene”), most preferably C₁₂-C₁₈ alkyl or alkenyl; each R² is a C₁₋₆ alkylene group, preferably an ethylene group; and A⁻ are defined as below. Fabric softening actives having the following formula:

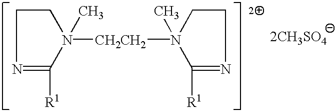

wherein R¹ is derived from oleic acid is available from Witco Company.

The following polyquaternary ammonium compounds are disclosed by reference herein as suitable for use in this invention: European Patent Application EP 0,803,498, A1, Robert O. Keys and Floyd E. Friedli, filed Apr. 25, 1997; British Pat. 808,265, issued Jan. 28, 1956 to Arnold Hoffman & Co., Incorporated; British Pat. 1,161,552, Koebner and Potts, issued Aug. 13, 1969; DE 4,203,489 A1, Henkel, published Aug. 12, 1993; EP 0,221,855, Topfl, Heinz, and Jorg, issued Nov. 3, 1986; EP 0,503,155, Rewo, issued Dec. 20, 1991; EP 0,507,003, Rewo, issued Dec. 20, 1991; EPA 0,803,498, published Oct. 29, 1997; French Pat. 2,523,606, Marie-Helene Fraikin, Alan Dillarstone, and Marc Couterau, filed Mar. 22, 1983; Japanese Pat. 84-273918, Terumi Kawai and Hiroshi Kitamura, 1986; Japanese Pat. 2-011,545, issued to Kao Corp., Jan. 16, 1990; U.S. Pat. No. 3,079,436, Hwa, issued Feb. 26, 1963; U.S. Pat. No. 4,418,054, Green et al., issued Nov. 29, 1983; U.S. Pat. No. 4,721,512, Topfl, Abel, and Binz, issued Jan. 26, 1988; U.S. Pat. No. 4,728,337, Abel, Topfl, and Riehen, issued Mar. 1, 1988; U.S. Pat. No. 4,906,413, Topfl and Binz, issued Mar. 6, 1990; U.S. Pat. No. 5,194,667, Oxenrider et al., issued Mar. 16, 1993; U.S. Pat. No. 5,235,082, Hill and Snow, issued Aug. 10, 1993; U.S. Pat. No. 5,670,472, Keys, issued Sep. 23, 1997; Weirong Miao, Wei Hou, Lie Chen, and Zongshi Li, Studies on Multifunctional Finishing Agents, Riyong Huaxue Gonye, No. 2, pp. 8-10, 1992; Yokagaku, Vol. 41, No. 4 (1992); and Disinfection, Sterilization, and Preservation, 4^{th} Edition, published 1991 by Lea & Febiger, Chapter 13, pp. 226-30. All of these references are incorporated herein, in their entirety, by reference. The products formed by quaternization of reaction products of fatty acid with N,N,N′,N′, tetraakis(hydroxyethyl)-1,6-diaminohexane are also disclosed as suitable for this invention. Some nonlimiting structural examples produced by this reaction are given in WO No. 01/34743, published May 17, 2001 to Sakkab et al., incorporated herein by reference.

The compositions can also contain other fabric softener active(s) as given in U.S. Pat. No. 4,661,269, issued Apr. 28, 1987, to Trinh et al., said patent being incorporated herein by reference.

In the cationic nitrogenous salts herein, the anion A⁻, which is any softener compatible anion, provides electrical neutrality. Most often, the anion used to provide electrical neutrality in these salts is from a strong acid, especially a halide, such as chloride, bromide, or iodide. However, other anions can be used, such as methylsulfate, ethylsulfate, acetate, formate, sulfate, carbonate, and the like. Chloride and methylsulfate are preferred herein as anion A. The anion can also, but less preferably, carry a double charge in which case A⁻ represents half a group.

It will be understood that all mixtures and combinations of the softener structures disclosed above are suitable for use in this invention.

It is preferable that fabric softening compositions of the present invention do not contain paraffinic wax, emulsified paraffinic wax, or high levels of N-octadecyl-N,N-dimethylamine oxide, that is, wherein the N-octadecyl-N,N-dimethylamine oxide-to-quaternary ammonium softening active weight ratio is about 20:80 or higher. The present invention does not relate to compositions comprising aminofunctional silicones without quaternary ammonium softening actives and/or their amine precursors.

Dryer-Added Compositions. The fabric softening active, or actives, which are useful in the dryer-added fabric softening composition of the present invention can be selected from cationic, nonionic, amphoteric and/or anionic fabric softening active. In the most common execution, the fabric conditioning composition is releasably affixed on the substrate to provide a weight ratio of conditioning composition to dry substrate ranging from about 10:1 to about 0.5:1, preferably from about 5:1 to about 1:1.

The typical cationic fabric softening actives include the water-insoluble quaternary ammonium fabric softening actives, the most commonly used having been di(long alkylchain)dimethylammonium (C1-C4 alkyl)sulfate or chloride, preferably the methyl sulfate. Nonlimiting examples of suitable actives of this and other types of quaternary ammonium fabric softening actives, including the rapidly biodegradable and environmentally friendly DEQA actives are given in U.S. Pat. No. 6,107,270 issued Aug. 22, 2000 to Smith et al., and U.S. Pat. No. 6,277,796 issued Aug. 21, 2001 to Sivik et al., said patents are incorporated herein by reference. These patents also described the other fabric softening actives that can be used in the present invention, such as nonionic softening actives, carboxylic acid salts of tertiary amines and/or ester amines, high molecular weight fatty acids, and the like. These patents also described nonlimiting examples of other optional ingredients, such as soil release agent, cyclodextrin/perfume complex, chlorine scavenger, dye transfer inhibitor, antioxidant/stabilizer, and the like, and preferred levels of softening actives and optional ingredients.

Perfume

The fabric softening compositions useful in the articles and kits of the present invention can contain perfume to provide a good odor to fabrics. Any type of perfume can be incorporated into the compositions of the present invention. The preferred perfume ingredients are those suitable for use to apply on fabrics and garments. Typical examples of such preferred ingredients are given in U.S. Pat. No. 5,445,747, issued Aug. 29, 1995 to Kvietok et al., incorporated herein by reference. Perfume can be present at a level of from 0% to about 10%, preferably from about 0.1% to about 5%, and more preferably from about 0.2% to about 3%, by weight of the finished composition.

During the laundry process, a substantial amount of perfume in the rinse-added fabric softening composition is lost with the rinse water and in the subsequent drying (either line drying or machine drying). Similarly, a substantial amount of perfume in the dryer-added fabric softening composition is lost with the hot air of the automatic tumbling drying machine. This has resulted in both a waste of unusable perfume that is not deposited on laundered fabrics, and a contribution to the general air pollution from the release of volatile organic compounds to the air. Therefore it is preferable to select the perfume ingredients that can effectively provide the best residual perfume odor benefit on fabrics. Such perfume ingredients are called “substantive” perfume ingredients. It is preferable that the softening compositions of the present invention contain a substantive perfume composition characterized by comprising at least about 25%, preferably at least about 40%, more preferably at least about 60%, and even more preferably at least about 75%, by weight of the perfume of substantive perfume ingredients.

Substantive perfume ingredients to be used in the rinse-added fabric softening compositions of the present invention have properties that are different from substantive perfume ingredients to be used in the dryer-added fabric softening compositions of the present invention.

For rinse-added compositions, the substantive perfume ingredients are characterized by their boiling points (B.P.) and their octanol/water partition coefficient (P). Octanol/water partition coefficient of a perfume ingredient is the ratio between its equilibrium concentration in octanol and in water. The substantive perfume ingredients for rinse-added compositions of the present invention has a B.P., measured at the normal, standard pressure, of about 240° C. or higher, preferably of about 250° C. or higher, and an octanol/water partition coefficient P of about 1,000 or higher. Since the partition coefficients of the perfume ingredients of this invention have high values, they are more conveniently given in the form of their logarithm to the base 10, logP. Thus the substantive perfume ingredients for rinse-added compositions of the present invention have logP of about 3 or higher.

The logP of many perfume ingredients has been reported; for example, the Pomona92 database, available from Daylight Chemical Information Systems, Inc. (Daylight CIS), Irvine, Calif., contains many, along with citations to the original literature. However, the logP values are most conveniently calculated by the “CLOGP” program, also available from Daylight CIS. This program also lists experimental logP values when they are available in the Pomona92 database. The “calculated logP” (ClogP) is determined by the fragment approach on Hansch and Leo (cf., A. Leo, in Comprehensive Medicinal Chemistry, Vol. 4, C. Hansch, P. G. Sammens, J. B. Taylor and C. A. Ransden, Eds., p. 295, Pergamon Press, 1990, incorporated herein by reference). The fragment approach is based on the chemical structure of each perfume ingredient, and takes into account the numbers and types of atoms, the atom connectivity, and chemical bonding. The ClogP values, which are the most reliable and widely used estimates for this physicochemical property, are preferably used instead of the experimental logP values in the selection of perfume ingredients which are useful in the present invention. Thus the substantive perfume ingredients for rinse-added compositions of the present invention have ClogP of about 3 or higher.

The boiling points of many perfume ingredients are given in, e.g., “Perfume and Flavor Chemicals (Aroma Chemicals),” Steffen Arctander, published by the author, 1969, incorporated herein by reference. Other boiling point values can be obtained from different chemistry handbooks and data bases, such as the Belistein Handbook, Lange's Handbook of Chemistry, and the CRC Handbook of Chemistry and Physics. When a boiling point is given only at a different pressure, usually lower pressure than the normal pressure of 760 mm Hg, the boiling point at normal pressure can be approximately estimated by using boiling point-pressure nomographs, such as those given in “The Chemist's Companion,” A. J. Gordon and R. A. Ford, John Wiley & Sons Publishers, 1972, pp. 30-36. The boiling point values can also be estimated via a computer program that is described in “Development of a Quantitative Structure—Property Relationship Model for Estimating Normal Boiling Points of Small Multifunctional Organic Molecules”, David T. Stanton, Journal of Chemical Information and Computer Sciences, Vol. 40, No. 1, 2000, pp. 81-90, incorporated herein by reference.

Non-limiting examples of the preferred substantive perfume ingredients for use in rinse-added fabric softening compositions of the present invention include: allyl cyclohexane propionate, ambrettolide, amyl benzoate, amyl cinnamate, amyl cinnamic aldehyde, amyl cinnamic aldehyde dimethyl acetal, iso-amyl salicylate, aurantiol (trade name for hydroxycitronellal-methylanthranilate), benzophenone, benzyl salicylate, para-tert-butyl cyclohexyl acetate, iso-butyl quinoline, beta-caryophyllene, cadinene, cedrol, cedryl acetate, cedryl formate, cinnamyl cinnamate, cyclohexyl salicylate, cyclamen aldehyde, dihydro isojasmonate, diphenyl methane, diphenyl oxide, dodecalactone, iso E super (trade name for 1-(1,2,3,4,5,6,7,8-octahydro-2,3,8,8-tetramethyl-2-naphthalenyl)-ethanone), ethylene brassylate, ethyl methyl phenyl glycidate, ethyl undecylenate, exaltolide (trade name for 15-hydroxyentadecanoic acid, lactone), galaxolide (trade name for 1,3,4,6,7,8-hexahydro-4,6,6,7,8,8-hexamethylcyclopenta-gamma-2-benzopyran), geranyl anthranilate, geranyl phenyl acetate, hexadecanolide, hexenyl salicylate, hexyl cinnamic aldehyde, hexyl salicylate, alpha-irone, lilial (trade name for para-tertiary-butyl-alpha-methyl hydrocinnamic aldehyde), linalyl benzoate, 2-methoxy naphthalene, methyl dihydrojasmone, gamma-n-methyl ionone, musk indanone, musk ketone, musk tibetine, oxahexadecanolide-10, oxahexadecanolide-11, patchouli alcohol, phantolide (trade name for 5-acetyl-1,1,2,3,3,6-hexamethyl indan), phenyl ethyl benzoate, phenylethylphenyl acetate, phenyl heptanol, phenyl hexanol, alpha-santalol, thibetolide (trade name for 15-hydroxypentadecanoic acid, lactone), delta-undecalactone, gamma-undecalactone, vetiveryl acetate, yara-yara, ylangene, and mixtures thereof. Thus, when a substantive perfume composition which is composed primarily of ingredients having a B.P. at about 250° C. or higher, and a ClogP of about 3 or higher, is used in a rinse-added fabric softening composition, the perfume is very effectively deposited on fabrics and remains substantive on fabrics after the rinsing and drying (line or machine drying) steps for the aesthetic benefit, and is not substantially lost during the laundry process, or wasted, without benefiting the laundered clothes. Together, the energy saving from a shorter dryer drying time, the rapid biodegradability of the fabric softening actives, and the minimization of perfume loss, constitute a laundry process that minimizes an impact to the environment.

For dryer-added fabric softening compositions, the substantive perfume ingredients are characterized by their boiling points (B.P.). The substantive perfume ingredients for dryer-added compositions of the present invention has a B.P. of about 240° C. or higher, preferably of about 250° C. or higher.

Non-limiting examples of the preferred substantive perfume ingredients for use in dryer-added fabric softening compositions of the present invention include: allyl cyclohexane propionate, ambrettolide, amyl benzoate, amyl cinnamate, amyl cinnamic aldehyde, amyl cinnamic aldehyde dimethyl acetal, iso-amyl salicylate, aurantiol (trade name for hydroxycitronellal-methyl anthranilate), benzophenone, benzyl salicylate, iso-butyl quinoline, beta-caryophyllene, cadinene, cedrol, cedryl acetate, cedryl formate, cinnamyl cinnamate, cyclohexyl salicylate, cyclamen aldehyde, dihydro isojasmonate, diphenyl methane, diphenyl oxide, dodecalactone, iso E super (trade name for 1-(1,2,3,4,5,6,7,8-octahydro-2,3,8,8-tetramethyl-2-naphthalenyl)-ethanone), ethylene brassylate, ethyl methyl phenyl glycidate, ethyl undecylenate, iso-eugenol, exaltolide (trade name for 15-hydroxypentadecanoic acid, lactone), galaxolide (trade name for 1,3,4,6,7,8-hexahydro-4,6,6,7,8,8-hexamethylcyclopenta-gamma-2-benzopyran), geranyl anthranilate, hexadecanolide, hexenyl salicylate, hexyl cinnamic aldehyde, hexyl salicylate, lilial (trade name for para-tertiary-butyl-alpha-methyl hydrocinnamic aldehyde), linalyl benzoate, 2-methoxy naphthalene, methyl cinnamate, methyl dihydrojasmonate, beta-methyl naphthyl ketone, musk indanone, musk ketone, musk tibetine, myristicin, delta-nonalactone, oxahexadecanolide-10, oxahexadecanolide-11, patchouli alcohol, phantolide (trade name for 5-acetyl-1,1,2,3,3,6-hexamethylindan), phenyl ethyl benzoate, phenylethylphenylacetate, phenyl heptanol, phenyl hexanol, alpha-santalol, thibetolide (trade name for 15-hydroxypentadecanoic acid, lactone), tonal id, delta-undecalactone, gamma-undecalactone, vetiveryl acetate, yara-yara, allyl phenoxy acetate, cinnamic alcohol, cinnamic aldehyde, cinnamyl formate, coumarin, dimethyl benzyl carbinyl acetate, ethyl cinnamate, ethyl vanillin (3-methoxy-4-ethoxy benzaldehyde), eugenol, eugenyl acetate, heliotropine, indol, isoeugenol, koavone, methyl-beta-naphthyl ketone, methyl cinnamate, methyl dihdrojasmonate, beta methyl naphthyl ketone, methyl-n-methyl anthranilate, delta-nonalactone, gamma-nonalactone, para methoxy acetophenone (acetanisole), phenoxy ethyl iso butyrate, phenoxy ethyl propionate, piperonal, triethyl citrate, vanillin, and mixtures thereof. Other enduring perfume ingredients useful in the present invention include methyl-N-methyl anthranilate, benzyl butyrate, benzyl iso valerate, citronellyl isobutyrate, citronellyl propionate, delta-nonalactone, dimethyl benzyl carbinyl acetate, dodecanal, geranyl acetate, geranyl isobutyrate, gamma-ionone, para-isopropyl phenylacetaldehyde, cis jasmone, methyl eugenol, hydroxycitronellal, phenoxy ethanol, benzyl iso valerate, anisic aldehyde, cuminic alcohol, cis-jasmone, methyl eugenol, and mixtures thereof. Thus, when a substantive perfume composition which is composed primarily of substantive perfume ingredients having a B.P. of about 250° C. or higher, they remain substantive on fabrics after the drying step, and minimize the perfume lost during the laundry process.

The preferred perfume compositions for use in the fabric softening composition of the present invention contain at least 4 different substantive perfume ingredients, preferably at least 5 substantive perfume ingredients, more preferably at least 6 different substantive perfume ingredients, and even more preferably at least 7 different substantive perfume ingredients. Most common perfume ingredients which are derived from natural sources are composed of a multitude of components. When each such material is used in the formulation of the preferred perfume compositions of the present invention, it is counted as one single ingredient, for the purpose of defining the invention.

It is also preferred to use materials that can slowly release perfume ingredients after the fabric is treated by the fabric care composition of this invention. Examples of materials of this type are given in U.S. Pat. No. 5,531,910, Severns et al., issued Jul. 2, 1996, said patent being incorporated herein by reference.

The perfumes useful in the present invention compositions are preferably substantially free of halogenated materials and nitromusks.

Suitable solvents, diluents or carriers for perfumes ingredients mentioned above are for examples, ethanol, isopropanol, diethylene glycol, monoethyl ether, dipropylene glycol, diethyl phthalate, triethyl citrate, isopropyl myristate, benzyl benzoate, etc. The amount of such solvents, diluents or carriers incorporated in the perfumes is preferably kept to the minimum needed to provide a homogeneous perfume solution. These materials are not counted in the formulation of the substantive perfume compositions of the present invention.

The substantive perfume compositions are added to the fabric softening composition as free perfume. For dryer-added compositions, non-substantive perfume ingredients can be delivered to fabrics without extensive loss by incorporating them in a perfume carrier or microencapsulating them in other materials. The preferred carrier is cyclodextrins which is disclosed in, e.g., U.S. Pat. No. 5,234,610, issued Aug. 10, 1993 to Gardlik et al. Thus, optionally but preferably, the dryer-added fabric softening compositions additionally contain perfume/cyclodextrin complexes.

The fabric softening composition of the present invention can preferably be unscented or perfume free. “Unscented” in this context refers to compositions that contain only a minor amount of fragrance material(s) so as to mask any malodor that might be associated with the ingredients, and/or their minor components and/or their contaminants, that are used to prepare the fabric softening composition of the present invention, but not enough to provide a noticeable perfume odor. Perfume free composition does not contain perfume ingredients. Unscented and perfume free compositions have the least amount of volatile organic compounds, and are thus the most environmental friendly.

Adjunct Ingredients

The following are non-limiting examples of adjunct ingredients that are suitable for use in the fabric softening compositions of the present invention.

a) Carriers and Solvents

Liquid fabric softening compositions useful in the present invention will typically contain water as well as one or more water soluble and/or organic solvents. Examples of low molecular weight water soluble and organic solvents are described in U.S. Pat. No. 5,861,270, Trinh, et al. issued Jan. 19, 1999 which is incorporated herein by reference. More specifically, monols and diols for use in formulating clear or translucent liquid fabric compositions are detailed in U.S. Pat. No. 5,747,443, Wahl, et al., May 5, 1998.

b) Color Care Agents

“Color Care Agents,” as used herein refers to chelants, dye fixatives and dye transfer inhibitors. A description of color care agents for use in the fabric softening compositions of the present invention may be found in U.S. Pat. No. 6,107,270, Smith, et al. Aug. 22, 2000, the description of which is incorporated herein by reference.

c) Concentration Aids

Concentrated fabric softening compositions of the present invention may require organic and/or inorganic concentration aids to go to even higher concentrations and/or to meet higher stability standards depending on the other ingredients. Surfactant concentration aids are typically selected from the group consisting of single long chain alkyl cationic surfactants; nonionic surfactants; amine oxides; fatty acids; or mixtures thereof, typically used at a level of from 0 to about 15% of the composition. Non-ionic alkoxylated surfactants are described in greater detail in WO 99/09122, Demeyere, et al., published Feb. 25, 1999, which is incorporated herein by reference.

Inorganic viscosity/dispersibility control agents that can also act like or augment the effect of the surfactant concentration aids, include water-soluble, ionizable salts. A wide variety of ionizable salts can be used. Examples of suitable salts are the halides of the Group IA and IIA metals of the Periodic Table of the Elements, e.g., calcium chloride, magnesium chloride, sodium chloride, potassium bromide, and lithium chloride. The ionizable salts are particularly useful during the process of mixing the ingredients to make the compositions herein, and later to obtain the desired viscosity. The amount of ionizable salts used depends on the amount of active ingredients used in the compositions and can be adjusted according to the desires of the formulator. Typical levels of salts used to control the composition viscosity are from about 20 to about 20,000 parts per million (ppm), preferably from about 20 to about 11,000 ppm, by weight of the composition.

d) Soil Release Agents

Any polymeric soil release agent known to those skilled in the art can optionally be employed in the compositions and processes of this invention. Polymeric soil release agents are characterized by having both hydrophilic segments, to hydrophilize the surface of hydrophobic fibers, such as polyester and nylon, and hydrophobic segments, to deposit upon hydrophobic fibers and remain adhered thereto through completion of washing and rinsing cycles and, thus, serve as an anchor for the hydrophilic segments. This can enable stains occurring subsequent to treatment with the soil release agent to be more easily cleaned in later washing procedures. The following, all included herein by reference, describe soil release polymers suitable for use in the present invention. U.S. Pat. No. 3,959,230 Hays, issued May 25, 1976; U.S. Pat. No. 3,893,929 Basadur, issued Jul. 8, 1975; U.S. Pat. No. 4,000,093, Nicol, et al., issued Dec. 28, 1976; U.S. Pat. No. 4,702,857 Gosselink, issued Oct. 27, 1987; U.S. Pat. No. 4,968,451, Scheibel et al., issued November 6; U.S. Pat. No. 4,702,857, Gosselink, issued Oct. 27, 1987; U.S. Pat. No. 4,711,730, Gosselink et al., issued Dec. 8, 1987; U.S. Pat. No. 4,721,580, Gosselink, issued Jan. 26, 1988; U.S. Pat. No. 4,877,896, Maldonado et al., issued Oct. 31, 1989; U.S. Pat. No. 4,956,447, Gosselink et al., issued Sep. 11, 1990; U.S. Pat. No. 5,415,807 Gosselink et al., issued May 16, 1995; European Patent Application 0 219 048, published Apr. 22, 1987 by Kud, et al. Further suitable soil release agents are described in U.S. Pat. No. 4,201,824, Violland et al.; U.S. Pat. No. 4,240,918 Lagasse et al.; U.S. Pat. No. 4,525,524 Tung et al.; U.S. Pat. No. 4,579,681, Ruppert et al.; U.S. Pat. No. 4,240,918; U.S. Pat. No. 4,787,989; U.S. Pat. No. 4,525,524; EP 279,134 A, 1988, to Rhone-Poulenc Chemie; EP 457,205 A to BASF (1991); and DE 2,335,044 to Unilever N. V., 1974.

e) Stabilizers

The term “stabilizer,” as used herein, includes antioxidants and reductive agents. These assure good odor stability under long-term storage conditions for the compositions and compounds stored in molten form. The use of antioxidants and reductive agent stabilizers is especially critical for low scent products (low perfume). Examples of antioxidants that can be added to the compositions of this invention include a mixture of ascorbic acid, ascorbic palmitate, propyl gallate, available from Eastman Chemical Products, Inc., under the trade names Tenox® PG and Tenox S-1; a mixture of BHT (butylated hydroxytoluene), BHA (butylated hydroxyanisole), propyl gallate, and citric acid, available from Eastman Chemical Products, Inc., under the trade name Tenox-6; butylated hydroxytoluene, available from UOP Process Division under the trade name Sustane® BHT; tertiary butylhydroquinone, Eastman Chemical Products, Inc., as Tenox TBHQ; natural tocopherols, Eastman Chemical Products, Inc., as Tenox GT-1I/GT-2; and butylated hydroxyanisole, Eastman Chemical Products, Inc., as BHA; long chain esters (C₈-C₂₂) of gallic acid, e.g., dodecyl gallate; Irganox® 1010; Irganox® 1035; Irganox® B 1171; Irganox® 1425; Irganox® 3114; Irganox® 3125; and mixtures thereof; preferably Irganox® 3125, Irganox® 1425, Irganox® 3114, and mixtures thereof; more preferably Irganox® 3125 alone or mixed with citric acid and/or other chelators such as isopropyl citrate, Dequest® 2010, available from Monsanto with a chemical name of 1-hydroxyethylidene-1,1-diphosphonic acid (etidronic acid), and Tiron®, available from Kodak with a chemical name of 4,5-dihydroxy-m-benzenesulfonic acid/sodium salt, EDDS, and DTPA®, available from Aldrich with a chemical name of diethylenetriaminepentaacetic acid.

f) Thickening Agents

Dryer added fabric softeners will preferably contain a thickening agent. Such agents are well described in U.S. Pat. No. 6,169,067 B1, Childs, et al., Jan. 2, 2001 which is incorporated herein by reference.

g) Other Adjunct Ingredients

The present invention can include other adjunct components (minor components) conventionally used in textile treatment compositions, for example, colorants, preservatives, brighteners, opacifiers, dispersibility aids, anti-shrinkage agents, anti-wrinkle agents, fabric crisping agents, spotting agents, bactericides, germicides, fungicides, anti-corrosion agents, antifoam agents, and the like.

The above adjunct ingredients and other suitable ingredients useful in fabric softener containing compositions are given in copending U.S. patent application Ser. No. 08/983,542, filed Sep. 25, 1998, Trinh et al., incorporated herein by reference.

B. Associated Instructions

1. Instructions

The articles, kits and methods of the present invention further comprise a set of instructions in association with a fabric softening composition, dryer or fabric article. A set of instructions is essential to obtaining the benefits of the present invention because consumers are unaware of such benefits. More specifically, consumers are not aware that the use of a fabric softening composition will reduce the drying time of fabric treated with such a composition. Consumers are not aware that certain softening actives are more rapidly biodegradable than others or that the use of certain of perfume components are more substantive such that the selection of softening compositions having such actives and perfume components have an improved environmental impact. Consumers are unaware that unsaturated fabric softening actives provide this reduction in drying time, although such actives are known to be more absorbent than their saturated counterparts, and in fact can provide a greater reduction in drying times than their saturated counterparts. Consumers are unaware that repeated and consecutive applications of a fabric softening composition will provide progressively increasing reductions in drying time. Consumers are not aware that the application of an excessive amount of a fabric softening composition in a single application will actually reduce and/or eliminate the drying time benefit. The consumer needs to know the method of use, and the benefits from following the method of use in order to obtain the full value of the invention. As such, a set of instructions provided in association with a fabric softening composition, tumble dryer or fabric article is essential for the consumer to enjoy the benefits of the present invention.

The set of associated instructions can comprise an instruction to the consumer to the effect that treatment of a fabric with an effective amount of a fabric softening composition will reduce the drying time required for drying the treated fabric. The improved drying times referred to herein are drying times in tumble dryers that use heated air to dry wetted fabrics.

As used herein, “laundering process cycle” means any cleaning and/or refreshing process or procedure wherein the subject fabric is wetted with an aqueous composition either by immersion, dipping or by spray-on application and then dried. A typical laundering process cycle will include washing and rinsing the fabrics either by hand or in a manual or automated machine and then drying. However, a laundering process cycle should not be construed to exclude processes that do not require the washing and rinsing of the fabric.

Useful instructions can also comprise an instruction to treat fabrics in at least two consecutive laundering process cycles, preferably in all laundering process cycles, to obtain increasing reductions in dry time. Specifically, it has been observed that repeated applications of fabric softening compositions in consecutive laundering process cycles provides additional reduction in drying time than is achieved with a single application. Further applications have been observed to provide additional although diminishing improvements in drying times.

Notwithstanding the benefits of treating fabrics in a single application and in repeated applications it has also been observed that application of an excessive amount of fabric softening composition in a single application provides smaller improvements in drying times or no improvement. Where the fabric softening composition is a rinse added compositions it is preferable that the amount of fabric softening active added to the fabric load not exceed about 5 grams per kilogram of fabric, more preferably not exceeding about 4 grams, and even more preferably not exceed about 3 grams per kilogram of fabric. For dryer added compositions, it is preferred that the amount of fabric softener active be less than about 3 grams, preferably less than about 2 grams, and more preferably less than about 1.2 grams per kilogram of fabric.

Similarly, it is preferred that the set of instructions includes an instruction that where the composition is a rinse added fabric softening composition, that the level of fabric softening active be more than about 0.5 gram, preferably more than about 1 gram, and more preferably more than about 1.5 grams per kilogram of fabric. For dryer added fabric softening compositions, it is preferred that the level of fabric softening active be more than about 0.1 gram, preferably more than about 0.2 and more preferably more than about 0.3 gram per kilogram of fabric.

It is a preferred instruction of the articles, kits and methods of the present invention to instruct the consumer to use a fabric softening composition comprising a more rapidly biodegradable softener. Such softeners are described in detail above and are preferred because they tend to break down more rapidly in the environment.

It is a preferred instruction of the articles, kits and methods of the present invention to instruct the consumer to use a fabric softening composition comprising a fabric softening active that is at least partially unsaturated. Saturated fabric softening actives tend to be more hydrophobic in nature causing the fabrics treated with them to be less absorbent and to feel greasy to the touch. Unsaturated fabric softeners have been shown to be more absorbent than their saturated counterparts, and surprisingly, have been observed to provide greater reductions in drying time than saturated softener actives.

It is a preferred instruction of the articles, kits and methods of the present invention to instruct the consumer to use a fabric softening composition comprising a substantive perfume as described above, or to use a fabric softening composition that is unscented or perfume free. Substantive perfume minimize the use of volatile organic compounds and improve the environmental impact. Unscented and perfume free compositions have the least amount of volatile organic compounds, and are thus the most environmentally friendly.

It is a preferred instruction of the articles, kits and methods of the present invention to instruct the consumer to manually reduce the length of the dryer cycle where the dryer cycle is controlled by a programmed timer. Such an instruction should instruct the consumer to reduce the timed drying of fabrics by at least about 5%, preferably by at least about 6%, more preferably by at least about 7% and even more preferably by at least about 8% of the time required to dry wetted fabrics that have not been treated with a fabric softening composition.

It is a preferred instruction of the articles, kits and methods of the present invention to instruct the consumer to use a dryer that has an “automatic” or energy efficiency cycle. Typically, such dryers have a moisture sensor and associated circuitry for monitoring the level of moisture on or in the fabrics and using that information to control the dryer operation and termination. Even when such automated settings are selected by the consumer, the treatment of the fabrics with a fabric softening composition contributes to reducing the level of moisture in the fabric at a faster rate and thereby shortening the dryer time relative to drying untreated fabrics using the same automated settings.

It is also preferred that the set of instructions comprises recommendations and/or endorsements from government agencies, non-profit organizations, utility service providers, appliance manufacturers, and the like. By way of example, the U.S. Department of Energy rates the energy efficiencies of various products, and labels those that provide certain levels of energy savings with its ENERGY STAR mark. It is preferred that the set of instructions comprises an endorsement from the U.S. Department of Energy. Similarly, it is envisioned that utility service providers will endorse and recommend to its customers various ways in which to reduce their energy consumption, including the usage of fabric softening compositions to reduce the energy consumed in laundering clothes and other fabrics. Such endorsements and/or recommendations can be provided with the set of instructions association with fabric softening compositions, fabric dryers and/or fabric articles, or can be distributed directly by an entity such as a utility service provider to their customers. Further, it is envisioned that cooperative arrangements may be established between manufacturers and utility service providers for the distribution of such endorsements and recommendations in communications from the utility service provider, such as the customer's monthly bill.

2. Form of the Instructions

The set of instructions associated with the use and/or benefits of the fabric softening compositions, articles, kits and/or methods of the present invention can be provided via different means using a variety of media. In the most convenient and direct manner, the fabric softening composition will be marketed in a package and the set of instructions will be provided with the package, printed directly on the package label, on an information sheet provided with the package or on point of sale materials. Similarly, the set of instructions can be recorded in various electronic or computer readable forms and provided with the composition package.

It is also preferred to provide the instructions associated with the use and/or benefits of the fabric softening compositions, articles, kits and/or methods of the present invention via the mass media, such as the print media and/or the electronic media. Print media include, e.g., newspapers, magazines, journals, newsletters, brochures, billboard presentations, store displays, and the like, in, e.g., hard copy, or virtual, electronic format. Electronic media include means to communicate via electronic means and/or electromagnetic radiation, e.g., television, radio, global computer network, and the like. Electronic or computer readable forms can be posted and made available to the consumer for downloading from a website located on a global computer network.

Instructions concerning the use of a fabric softening composition are preferably in consumer-friendly language on packaging and/or in advertising (e.g., leaflets, coupons, displays, etc.). By consumer-friendly language, it is meant that consumers would be instructed how to use the product to achieve the best results. It is important that the instructions be as simple and clear as possible and it is envisioned that pictures and/or icons can be used, either with or without words to render the instructions more consumer-friendly. The set of instructions can be multi-lingual to be more easily understood by consumers who speak different languages. Special packaging design can also be advantageously used to convey instructions in a consumer-friendly fashion.

The units of measurement provided to consumers will reflect consumer understanding, e.g., English dosing units will be preferred in, e.g., the United States and the United Kingdom, and metric units will be used in, e.g., most European nations. Although all of the compositions and methods described hereinbelow are written in metric units; it is understood that these units will be converted into consumer-friendly language instructions in the actual product packaging, advertising, etc.

### II. Kits of the Present Invention

The kits of the present invention comprise a tumble dryer and a set of instructions associated with the dryer.

A. Fabric Tumble Dryer

The tumble dryers for use with the articles and in the kits and methods of the present invention are forced air tumble dryers that force heated air through a rotating drum containing wet fabrics in order to dry those fabrics. Traditionally, dryer manufactures have provided a timer for controlling the length of time the fabrics were subjected to the heated forced air. Such timers are still provided on more technically advanced dryers today and are commonly used by the consumer. The disadvantage of such timers is that the consumer typically prefers to “over dry” their fabrics during the initial timed period rather than face the possibility that the fabrics will still be damp and will require an additional timed period. This is typically accomplished by setting the temperature to a higher than necessary setting or setting the timer to an excessively long period. The result is excess consumption of energy, lost time, and damage to the consumer's fabrics due to unnecessarily pro-longed heat exposure.

Dryer manufacturers have attempted to make their machines more energy efficient by provided various sensors and circuitry for monitoring the level of moisture on the fabrics and adjusting the dry cycle accordingly. See U.S. Pat. Nos. 6,047,486, Reck, et al., Apr. 11, 2000, “Control System For A Dryer”, and 6,199,300 B1, Heater, et al., Mar. 13, 2001 “Method For Energy Efficient Control of a Dryer of Clothes” which are both incorporated herein by reference. Although the benefits of the present invention may be achieved with forced air dryers having only programmed timers, it is preferred that the articles as well as the kits and methods of the present invention utilize a dryer having an automated dry cycle setting that uses a moisture sensor and circuitry for controlling the drying of fabrics.

Moisture Sensors

Dryer manufacturers have attempted to reduce drying times by incorporating various sensors in their machines that will control the application of heat and the duration of the drying cycle as the fabrics begin to dry. In fact, many new dryers are outfitted with moisture sensors that will monitor the level of moisture on the surfaces of the fabrics in the rotating dryer. Typically, these sensors consist of parallel strips of conductive sensors that are used to determined the conductivity or resistance of the fabrics in the rotating dryer. As the fabrics begin to dry, various circuitry can be used to control the temperature or actuation of the heating elements of the dryer. It is quite common to include a program timer that is activated when the level of detected moisture reaches a predetermined level. The use of a timed sequence in conjunction with the moisture sensor insures that the fabrics are dry to the touch at the completion of the automated cycle.

Such moisture sensors are well known in the field of forced air tumble dryers and can range from sensors that measure the conductivity or resistance across fabrics in the dryer to humidity sensors that measure the moisture in the air vented from the dryer. It is envisioned that any such sensors and associated circuitry can be used in the kits and methods of the present invention. The following descriptions are non-limiting of such sensors and the methods that may be used to monitor the level of moisture in fabrics and control the removal of moisture one a preset level of moisture has been reached. The following patents are incorporated by reference.

U.S. Pat. No. 3,271,878 discloses an automatic moisture sensing circuit wherein DC voltage is applied to sensing rings. As the clothes dry, a capacitor C₃ is charged and when the capacitor voltage equals a predetermined voltage the capacitor discharges through a neon lamp that allows a second capacitor C₂ to charge. When the voltage across the capacitor C₃ drops below the ignition potential of the lamp, the lamp turns off. The neon lamp is thereby periodically rendered conductive until the second capacitor is sufficiently charged to trigger a thyratron that completes a circuit through a relay to de-energize the heater and motor. See also, U.S. Pat. No. 3,271,876, See also, U.S. Pat. Nos. 4,312,138; 3,782,001; 3,710,138; 3,651,579; 3,599,342; and 3,521,377.

U.S. Pat. No. 4,215,486 discloses a circuit for controlling the program timer, in which a storage capacitor charged from a DC voltage source together with laundry resistance resulting from wet laundry bridging two electrodes determine the duty cycle or frequency for an oscillator. The output of the oscillator is fed to a filter and from there as one input to a comparator. A reference value setter is fed to another input of the comparator and the output of the comparator is functionally connected to the program timer.

U.S. Pat. No. 4,327,502 senses voltage across the clothing that is amplified and used to charge a capacitor. Voltage across the capacitor is isolated from sensed voltage by the amplifier and is compared to a reference voltage. When the capacitor voltage falls below a certain level, a timer is run. As the clothes dry, the timer runs more frequently and for longer periods of time until it times out.

U.S. Pat. No. 4,385,451 discloses a sensor control that compares the sensed voltage across the clothes to a reference voltage. When the sensed voltage across the clothes exceeds the reference voltage for a period of time, it is determined that the clothes are dry and an output switch connected to a timer is closed to allow the cycle to run out. The '451 patent includes circuitry to limit the effects of static discharge. See also, U.S. Pat. No. 4,470,204.

U.S. Pat. No. 5,737,852 teaches a dryness control circuit for household clothes dryer including power supply circuit and a moisture sensing circuit. The power supply circuit provides a low voltage, DC power to the moisture sensing circuit. The moisture sensing circuit includes a moisture sensor having a pair of spaced-apart electrodes, a time delay circuit, an electro-static discharge attenuation circuit and a motor controller circuit. The motor controller circuit includes a control hysteresis or dead band in which operation of a timer motor is unaffected. The time delay and control hysteresis of the moisture control circuit cooperate to prevent false actuation or deactivation of the timer motor.

U.S. Pat. No. 6,067,845 teaches circuitry and methods for determining the polarization voltage that tends to form at the electrodes and corrupts the measured electrical conductivity of laundry that is measured by the electrodes.

B. Set of Associated Instructions

The set of instructions associated with the fabric dryer can comprise any of the instructions described above as instructions for use in association with the articles of the present invention. Again, a primary function of the instructions is to inform the consumer that they may treat fabrics with a fabric softening composition to reduce the drying time of those fabrics and/or improve the environmental impact of the laundry process.

### III. Methods of the Present Invention

A. A Method for Reducing the Drying Time of Wetted Fabrics

A method for reducing the drying time of wetted fabrics and/or improving the environmental impact of the laundry process includes the steps of providing a fabric softening composition and providing a set of instructions in association with the fabric softening composition, said set of instructions comprising an instruction to apply an effective amount of the fabric softening composition to fabric to reduce the drying time of the fabric in a fabric dryer and/or improve the environmental impact of the laundry process. A full description of various fabric softening compositions that are useful in this method have been detailed above and will not be repeated here.

The use or application of the fabric softening composition may be at any time prior to or during the drying of the fabrics. Therefore, softening compositions that are designed for application in the wash or rinse cycles, spray-on compositions and dryer-added compositions may all be used to advantage in the methods of the present invention. When the composition is a rinse added fabric softening composition, it is preferred that the level of fabric softening active used be from about 0.5 to about 5 grams, preferably from about 1 to about 4 grams, and more preferably from about 1.5 to about 3 grams of softening active per kilogram of fabric. Similarly, where a dryer-added fabric softening composition is preferred, the level of fabric softening active should be between about 0.1 and about 3 grams, preferably from about 0.2 to about 2 grams, and more preferably from about 0.3 to about 1.2 grams, of softening active per kilogram of fabric.

As noted above, repeated applications of the fabric softening composition have been observed to provide increasing benefits in drying time reductions over single applications. Therefore, it is preferred that a fabric softening composition be used in at least two consecutive laundry process cycles, and more preferably during every laundry process cycle to achieve maximum reductions in drying time. However, excess fabric softening composition should not be used during individual or single applications as such has been observed to be detrimental to reductions in drying time.

B. Method for Reducing the Energy Consumed During a Laundering Process

A method for reducing the energy consumed during a laundering process that includes drying wetted fabrics in a fabric dryer, the method including the application of a fabric softening composition to the fabrics, and drying the fabrics in a fabric dryer, wherein the amount of energy consumed is reduced by reducing the time and/or temperature required to dry the fabrics.

The fabric softening compositions and dryers for use in this method are described above in detail. The fabric dryer may operate on a simple program timer wherein the duration of the drying time is determined by the operator at the beginning of the cycle. If the cycle is too short that the fabrics will still be wet or damp at the conclusion of the cycle, requiring the timer to be reset and the dryer re-started. Commonly, the consumer will overestimate the length of time that will be required to fully dry the fabrics with the result that the dryer will continue to operate for some time after the fabrics are dry. This excess is time and energy that is wasted. Further, the excess heat exposure which can be greatest when all of the moisture has been removed can be damaging to the fabrics. Therefore, it is preferred that this method be carried out in a fabric dryer that has an automated or energy efficient setting that monitors the moisture of the fabrics and controls the operation of the dry based on the level of moisture detected.

C. Method for Reducing Fabric Damage Due to Exposure of Fabrics to Heat

A method for reducing fabric damage that is due to exposure of the fabrics to heat during a laundering process. This method comprises the steps of applying a fabric softening composition to the fabrics, and drying the fabrics in a fabric dryer, wherein the amount of fabric damage is reduced by reducing the time and/or temperature at which the fabrics are dried. The fabric softening compositions and dryers that are useful in the present method have been described hereinbefore.

Fabric damage associated with the use of tumble dryers is derived both from exposure of the fabrics to heat as well as the mechanical abrasion that occurs during tumbling. By reducing the exposure of the fabrics to heat and the abrasion that accompanies the tumbling by shortening or reducing the drying cycle, the damage to the fabric fibers is reduced and thus the useful life of the fabrics is increased.

It is further envisioned that fabric fiber damage will be reduced when using the articles, kits and methods of the present invention, because fabrics treated with a fabric softening composition may be dried over similar intervals but at lower temperature settings than were recommended for the fabrics.

D. Method of Teaching a Consumer to Conserve Energy

A method for teaching a consumer to conserve energy and/or improve the environmental impact of the laundry process. The method comprises the step of informing a consumer that the treatment of laundered fabrics with a fabric softening composition will enable the consumer to conserve energy by reducing the time required to dry those fabrics in a forced air tumble dryer. The consumer is informed of the benefit associated with the use of a fabric softening composition through a set of instructions associated with a fabric softening composition, a fabric dryer or with fabric articles. The set of instructions useful for informing the consumer are those described above in association with the articles, kits and methods of the present invention.

E. Method of Promoting the Use of Fabric Softening Compositions

A method for promoting the use of fabric softening compositions to improve the environmental impact of a laundry process, the method comprising the step of informing a consumer that the treatment of laundered fabrics with a fabric softening composition will reduce the time required to dry those fabrics in a forced air tumble dryer. The consumer is informed of the benefit associated with the use of a fabric softening composition through a set of instructions associated with a fabric softening composition, a fabric dryer or with fabric articles.

The set of instructions useful for informing the consumer are those described above in association with the articles, kits and methods of the present invention. In addition, the set of instructions can further comprise an instruction to the consumer that the use a fabric softening composition can reduce the drying time of fabrics to more equal the time required to wash the fabrics in an automated washing machine. The drying cycle is well known to exceed the washing cycle and thus is the time-limiting step. Shortening the drying step thus improves the entire domestic laundry operation.

What is claimed is:

1. An article of manufacture for reducing the drying time and/or temperature of wetted fabrics and/or improving the environmental impact of the laundry process, the article comprising:
a fabric softening composition; and
a set of instructions associated with the fabric softening composition, wherein the instructions comprise an instruction to apply an effective amount of the fabric softening composition to fabric to reduce the drying time and/or temperature of the fabric and/or improve the environmental impact of the laundering process.

2. The article of claim 1, wherein the set of instructions comprises an instruction to apply the fabric softening composition to the fabric in at least two consecutive laundering process cycles to further reduce the drying time over the reduction obtained from a single application of the fabric softening composition.

3. The article of claim 1, wherein the fabric softening composition further comprises a package for the composition and the set of instructions is provided on the package.

4. The article of claim 1, wherein the set of instructions comprises an instruction to reduce the timed drying of laundered fabrics by at least 5% of the time required to dry wetted fabrics that have not been treated with a fabric softening composition.

5. The article of claim 1, wherein the set of instructions comprises an instruction to use a forced air tumble dryer having a moisture sensor and circuitry to determine when to terminate the drying operation based on the moisture detected on the fabric.

6. The article of claim 1, wherein the fabric softening composition is selected from the group consisting of liquid rinse-added fabric softening composition and dryer added fabric softening composition.

7. The article of claim 6, wherein the fabric softening composition comprises dihydrocarbyl quaternary ammonium fabric softening compound, and/or amine precursor thereof, with each hydrocarbyl group being saturated, unsaturated, highly unsaturated, linear, branched, or combinations thereof.

8. The article of claim 6, wherein the fabric softening composition is a rinse-added fabric softening composition comprising fabric softening active, and the fabric softening active is used at a level of from about 0.5 to about 5 g of softening active per kilogram of fabric.

9. The article of claim 6, wherein the fabric softening composition is a dryer-added fabric softening composition comprising fabric softening active, and the fabric softening active is used at a level of from about 0.1 to about 3 g of softening active per kilogram of fabric.

10. The article of claim 6, wherein the fabric softening composition comprises dihydrocarbyl quaternary ammonium fabric softening compound that is rapidly biodegradable.

11. The article of claim 10, wherein each hydrocarbyl group of the fabric softening compound comprises a functional group selected from the group consisting of ester, amide, and mixtures thereof.

12. The article of claim 6, wherein the fabric softening composition comprises a softener active that is at least partially unsaturated.

13. The article of claim 1, wherein the fabric softening composition is unscented or perfume free.

14. The article of claim 6, wherein the fabric softening composition comprises from about 0.01% to about 10%, by weight of the finished composition, of a substantive perfume composition.

15. The article of claim 14, wherein the fabric softening composition is a liquid rinse-added fabric softening composition, and the substantive perfume composition comprises at least about 25%, by weight of the perfume composition, of perfume ingredients having a boiling point of about 250° C. or higher, and a ClogP of about 3 or higher, with ClogP being the calculated octanol/water partition coefficient (P) expressed as the logarithm to the base 10, logP.

16. The article of claim 14, wherein the fabric softening composition is a dryer-added fabric softening composition, and the substantive perfume composition comprises at least about 25%, by weight of the perfume composition, of perfume ingredients having a boiling point of about 250° C. or higher.

17. The article of claim 1, wherein the set of instructions further comprises instructions to:
apply the fabric softening composition to the fabrics and
dry the fabrics in a forced air tumble dryer.

18. The article of claim 1, wherein the set of instructions comprises words, pictures, icons or multi-lingual instructions.

19. A method for reducing the drying time of wetted fabrics and/or improve the environmental impact of the laundry process, said method comprising the steps of:
providing a fabric softening composition; and
providing a set of instructions in association with the fabric softening composition, said set of instructions comprising an instruction to apply the fabric softening composition to fabric to reduce the drying time in a force air dryer and/or improve the environmental impact of the laundering process.

20. The method of claim 19, wherein the set of instructions comprises an instruction to apply an effective amount of fabric softening composition to fabric.

21. The method of claim 19, wherein said set of instructions comprises an instruction to apply the fabric softening composition to fabric during at least two consecutive laundering process cycles, preferably in all laundering process cycles, to further reduce the drying time obtained from a single application of the fabric softening composition.

22. The method of claim 19, wherein the set of instructions comprises an instruction to reduce the timed drying of laundered fabrics by at least 5% of the time required to dry wetted fabrics that have not been treated with a fabric softening composition.

23. The method of claim 19, wherein the set of instructions comprises an instruction to use a forced air tumble dryer having a moisture sensor and circuitry to determine when to terminate the operation of the dryer based on the moisture detected on the fabric.

24. The method of claim 19, wherein the fabric softening composition is selected from the group consisting of liquid rinse-added fabric softening composition and dryer added fabric softening composition.

25. The method of claim 24, wherein the fabric softening composition is a rinse-added fabric softening composition comprising fabric softening active, and the fabric softening active is used at a level of from about 0.5 to about 5 g of softening active per kilogram of fabric.

26. The method of claim 24, wherein the fabric softening composition is a dryer-added fabric softening composition comprising fabric softening active, and the fabric softening active is used at a level of from about 0.1 to about 3 g of softening active per kilogram of fabric.

27. A method for reducing the energy consumed during a laundering process that includes drying wetted fabrics in a fabric dryer, the method comprising the steps of:
applying a fabric softening composition to the fabrics, and
drying the fabrics in a fabric dryer, wherein the amount of energy consumed is reduced by reducing the time and/or temperature required to dry the fabrics.

28. The method of claim 27, further comprising the step of re-applying a fabric softener to the fabric during at least two consecutive laundering process cycles to reduce the energy consumed when drying fabrics that have had a single application of fabric softening composition.
